(19) United States
(12) Patent Application Publication
(10) Pub. No.: US 2005/0076849 A1
(43) Pub. Date: Apr. 14, 2005

(54) Membrane compositions non-toxic to aquatic animal life and related methods

(75) Inventors: James A. Davis, Westfield, IN (US); Edward G. Kane, Carmel, IN (US); Patricia Aguilar-Suarez, Noblesville, IN (US)

Correspondence Address: Chief Intellectual Property Counsel;Bridgestone Americas Holding, Inc., 1200 Firestone Parkway, Akron, OH, 44317-0001, US

(73) Assignee: BFS Diversified Products, LLC

(21) Appl. No.: 10/683,604

(22) Filed: Oct. 10, 2003

(51) Int. Cl. A01K 61/00

(52) U.S. Cl. 119/204

(57) ABSTRACT

An aquaculture reservoir includes water contained by a liner material made from at least one ethylene-propylene-diene terpolymer, the liner material being cured with a curing agent and at least one thiazole accelerator and either a dithiocarbamate accelerator or a guanidine accelerator, but is devoid of thiuram accelerators. The liner is non-toxic to aquatic animals grown in the aquaculture reservoir. The liner is particularly useful for the aquaculture of shrimp and crayfish.

### TECHNICAL FIELD

This invention relates generally to sheeting material used in the aquaculture industry to line tanks, ponds and the like reservoirs. More particularly, the present invention relates to a sheeting material that is non-toxic to shrimp and other aquatic animal life. A method is also provided for growing shrimp or other aquatic animals that includes the step of employing this sheeting material as a liner in an aquaculture reservoir.

### BACKGROUND OF THE INVENTION

The cultivation of fish and shellfish via aquaculture is well known but relatively recent. In aquaculture, fish or shellfish are typically grown under conditions where food, temperature and the like are optimized. This may include growing the aquatic animals in aerated ponds, or in recirculating aquaculture facilities where the aquatic animals may be grown to a higher density and size. Achieving optimal efficiency, including optimal densities of animal to water and optimal size of the animals, requires strict control of growth conditions. This includes water oxygenation and filtration, as well as waste removal.

One of the most toxic waste products that must be removed in aquaculture is ammonia. Ammonia is produced by fish and shellfish in proportion to the amount of feed provided and the protein content of that feed. Even at low levels, ammonia can cause stress on these animals and increase susceptibility to disease. It has also been shown to cause the aquatic animals to become less mobile and to have less of an appetite, thereby significantly reducing their growth. At higher levels, ammonia can be toxic.

A second waste product that also must not be permitted to accumulate is nitrite. Nitrite is the oxidation product of ammonia, and can also cause stress on the aquatic animals, susceptibility to disease and even death.

A standard method of removing nitrogenous compounds such as ammonia and nitrite from recirculating aquaculture facilities utilizes nitrifying bacteria to convert these toxic compounds to nitrate, which is less toxic to fish and shellfish than either ammonia or nitrite. Ammonia-oxidizing bacteria, such as Nitrosomonas, convert ammonia to nitrite, while nitrite-oxidizing bacteria, such as Nitrobacter, convert nitrite to nitrate. These bacteria may be provided in an aquaculture on an inert solid support such as on polyethylene chips.

Aquaculture tanks or ponds are often lined with liners made of synthetic polymer sheeting materials. Prior pond liners have typically been made of polymers such as high density polyethylene (HDPE), polyvinyl chloride (PVC), polypropylene and blends thereof. Ethylene-propylene-diene terpolymers (EPDMs) have also heretofore been used in the production of some liners for aquatic gardens and other aquaculture ponds where toxicity of the water was not deemed overly important, and offer low cost, flexibility and resistance to heat, light and oxygen. These latter factors make EPDMs more desirable for use in aquaculture reservoirs than other polymers. EPDM is normally prepared by vulcanization of the component monomers in the presence of sulfur or sulfur containing compounds, such as mercaptans. It has been noted however, that EPDM can be variable in its suitability for supporting animal growth in aquaculture. Low molecular weight compounds, commonly referred to as accelerator fragments, i.e., carbon disulfide, carbonyl sulfide, ammonia, amines, and carbon dioxide, may be present as a result of accelerator decomposition during the curing process. These materials may leach from the polymer into the water and adversely affect the aquatic animals being grown. While some compounds may be released by simple washing of the membrane, others may not be immediately released, but are released over time or in response to some external condition such as light, heat or a change in pH. These compounds may directly inhibit the aquatic animals, or they may indirectly inhibit them by inhibiting the growth of nitrifying bacteria necessary for ammonia and nitrite removal. While a screening method for determining if a given polymer sample will inhibit shrimp growth has been previously disclosed, the inhibitory component in some EPDM compositions has previously been unknown.

The manufacture of EPDM membranes and sheeting materials is well known in the art. EPDM and other polyolefinic materials have traditionally been reinforced with carbon black, coal fillers and related petroleum-derived materials or other similar fillers. Processing oils have also been traditionally used to aid in the manufacture of the sheeting materials. Still further, well known components such as stearic acid and zinc oxide have been used as common additives to EPDM rubber sheeting.

Therefore, there is a need for an aquaculture liner material that is non-toxic to aquatic animals, including particularly shrimp, crayfish, and other shellfish. There may also be a need for an aquaculture liner material that will not adversely affect the survival and/or growth of nitrifying bacteria in an aquaculture environment.

### SUMMARY OF INVENTION

The present invention seeks to provide an aquaculture reservoir comprising water contained by a liner material made of at least one ethylene-propylene-diene terpolymer (EPDM), wherein the EPDM liner material is cured by utilizing a curing agent and at least one thiazole accelerator and at least one accelerator selected from the group consisting of dithiocarbamate accelerators and guanidine accelerators, and is devoid of thiuram accelerators. When aquatic animals are provided in the water, an aquaculture is formed.

### PREFERRED EMBODIMENT FOR CARRYING OUT THE INVENTION

As noted hereinabove, the present invention is directed toward an aquaculture or aquaculture reservoir, and particularly, to a liner material therefor, that is non-toxic to aquatic animals and/or to nitrifying bacteria employed in the aquaculture. Such an aquaculture advantageously improves the viability of the aquatic life contained or grown therein. By “aquatic animals,” it is meant animal life forms suited to survive and thrive in water. Typically, such animals will consistently survive in water for up to at least 7 days, and many will survive for much longer periods of time, unless their environment is disturbed and/or their habitat is contaminated. Preferably, such aquatic animals include fish and shellfish. More preferably, such aquatic animals include crustaceans and mollusks. Even more preferably, such aquatic animals include shrimp and crayfish.

One embodiment of the present invention may be directed towards a particular liner material comprising at least one ethylene-propylene-diene terpolymer (EPDM), wherein the liner material is cured by utilizing a curing agent and at least one thiazole accelerator and at least one accelerator selected from the group consisting of dithiocarbamate accelerators and guanidine accelerators, and is devoid of thiuram accelerators. In this particular embodiment, the liner material comprises an amorphous EPDM. An amorphous EPDM is defined herein as one having less than 1 percent by weight crystallinity. The liner material of the present invention may also include one or more EPDM polymers.

The term EPDM is used in the sense of its definition as found in ASTM-D-1418-94 and is intended to mean a terpolymer of ethylene, propylene and a diene monomer with the residual unsaturation portion of the diene in the side chain. Methods for preparing such EPDM terpolymers are well known in the art. One illustrative method can be found in U.S. Pat. No. 3,280,082, the disclosure of which is incorporated herein by reference. Other illustrative methods can be found, for example, in Rubber and Chemistry & Technology, Vol. 45, No. 1, Division of Rubber Chemistry (March 1992); Morton, Rubber Technology, 2d ed., Chapter 9, Van Nostrand Reinhold Company, New York (1973); Polymer Chemistry of Synthetic Elastomers, Part II, High Polymer Series, Vol. 23, Chapter 7, John Wiley & Sons, Inc. New York (1969); Encyclopedia of polymer Science and Technology, Vol.6, pp.367-68, Interface Publishers, a division of John Wiley & Sons, Inc., New York (1967); Encyclopedia of Polymer Science and Technology, Vol. 5, p. 494, Interface Publishers, a division of John Wiley & Sons, Inc., New York (1966); and Synthetic Rubber Manual, 8th ed., International Institute of Synthetic Rubber Producers, Inc. (1980).

Preferably, the aquaculture liner material has from about 60 to about 95 weight percent ethylene and from 1 to about 12 weight percent of the diene with the balance of the polymer being propylene or some other similar olefin type polymer. Preferably, the EPDM terpolymer may have from about 2 to about 3.2 weight percent unsaturation.

The diene monomer utilized in forming the EPDM terpolymer is preferably a non-conjugated diene. Illustrative examples of non-conjugated dienes which may be employed are dicyclopentadiene; alkyldicyclopentadiene; 1,4-pentadiene; 1,4-hexadiene; 1,5-hexadiene; 1,4-heptadiene; 2-methyl-1,5-hexadiene; cyclooctadiene; 1,4-octadiene; 1,7-octadiene; S-ethylidene-2-norbornene; 5-n-propylidene-2-norbornene; 5-(2-methyl-2-butenyl)-2-norbornene and the like.

A typical EPDM polymer suitable for use in the present invention is Keltan® 2318, an EPDM terpolymer having a Mooney Viscosity (ML₄ at 125° C.) of about 63 and 64; an ethylene content of between about 67.5 and 69.5 weight percent; a crystallinity of less than 1 percent as determined by DSC technique; and about 2.4 to about 2.65 weight percent of unsaturation (presumably, 5-ethylidene-2-norbornene), with the balance of the polymer being polypropylene.

Other useful EPDM polymers include Royalene® X4611 (Uniroyal Chemical Co.) and Vistalon® VX 9303 HT (ExxonMobil Chemical Co.). Royalene X4611 has a Mooney Viscosity (ML₄ at 125° C.) of from about 67 to about 68.5; an ethylene content of from about 68 to about 69.5 weight percent; a crystallinity of less than 1 percent as determined by DSC technique; and from about 2.5 to about 2.8 weight percent of unsaturation (presumably, 5-ethylidene-2-norbornene), with the balance of the polymer being propylene. Vistalon® VX9303 HT has a Mooney Viscosity (ML₄ at 125° C.) of about 64; an ethylene content of from about 67.5 to about 69 weight percent; a crystallinity of less than 1 percent as determined by DSC technique; and from about 2.5 to about 2.8 weight percent of unsaturation (presumably, 5-ethylidene-2-norbornene), with the balance of the polymer again being propylene.

While any EPDM polymer or combination of EPDM polymers may be used in the present invention without necessarily departing from the scope of the present invention, at least one particular embodiment of the EPDM liner material of the present invention has only up to about 1 weight percent crystallinity, from the ethylene component, meaning the EPDM polymer is amorphous. Heretofore, it is believed that no liner material has existed which includes an amorphous EPDM polymer and the particular curing agents and accelerators noted above, and particularly being devoid of thiuram accelerators.

As noted hereinabove, more than one EPDM may be employed. Where more than one EPDM is employed, it is preferred that the EPDM rubbers be blended to form the rubber composition. A typical EPDM polymer blend may include such EPDM polymers as are available under the tradenames Keltan® 2318 together with either Royalene® X4611 or Vistalon® VX 9303 HT. Preferably, the unsaturation in the polymer side chains is 5-ethylidene-2-norbornene (ENB). In a preferred embodiment, from about 40 to 100 percent of the first EPDM terpolymer is employed as the rubber component, and from 0 to about 60 percent of the second EPDM terpolymer, having slightly different properties from the first, is employed.

The compositions or compounds employed to form the liner material comprise 100 parts by weight of at least one EPDM, to which may be added fillers, as well as processing materials and, optionally, other components, all of which are discussed hereinbelow.

With respect first to the filler, suitable fillers are selected from the group consisting of reinforcing and non-reinforcing materials, and mixtures thereof, as are customarily added to rubber. Examples include such materials as carbon black, ground coal, calcium carbonate, clay, talc, silica, cryogenically ground rubber and the like. Generally, preferred fillers include carbon black, ground coal and various types of clays.

Carbon black is used in an amount of about 20 parts to about 300 parts per 100 parts of polymer (phr), preferably in an amount of about 60 to about 150 phr. The preferred range of carbon black herein (60 to 150 phr) is about equal to the amount of carbon black normally used in preparing sulfur cured EPDM sheeting. In one embodiment the carbon black is used in an amount of about 120 phr and in another embodiment about 130 phr. The carbon black useful herein is any carbon black. Preferred are furnace blacks such as GPF (general purpose furnace), FEF (fast extrusion furnace) and SRF (semi-reinforcing furnace). These carbon blacks may also be blended with minor amounts of more reinforcing blacks, i.e., HAF, ISAF, SAF and the like. For a complete description of such carbon blacks, see for example, The Vanderbilt Rubber Handbook, pp 408-424, RT Vanderbilt Co., Norwalk Conn. 06855 (1979).

The ground coal employed as a filler in the compositions of the invention is a dry, finely divided black powder derived from a low volatile bituminous coal. The ground coal has a particle size ranging from a minimum of 0.26 microns to a maximum of 2.55 microns with the average particle size of 0.69+/−0.46 as determined on 50 particles using Transmission Electron Microscopy. The ground coal produces an aqueous slurry having a pH of about 7.0 when tested in accordance with ASTM D-1512. A preferred ground coal of this type is designated Austin Black which has a specific gravity of 1.22+/−0.03, an ash content of 4.58% and a sulfur content of about 0.65%. Austin Black is commercially available from Coal Fillers, Inc., P.O. Box 1063, Bluefield, Va. Amounts range from about 5 to 65 phr with about 15 to 35 phr being preferred.

Essentially any cryogenically ground rubber may be employed as a filler in the composition of the invention. The preferred cryogenically ground rubbers are cryogenically ground EPDM, butyl, neoprene and the like. A preferred cryogenically ground rubber is a cryogenically ground EPDM rubber. The preferred cryogenically ground EPDM rubber is a fine black rubbery powder having a specific gravity of 1.129 +/−0.015 and a particle size ranging from about 30 to about 300 microns with an average particle size ranging from about 50 to about 80 microns. Amounts range from about 5 to 40 phr with about 10 to 25 phr being preferred.

Mixtures of Austin black (i.e., finely ground coal fines) and cryogenically ground rubber useful herein may be utilized as a partial replacement for carbon black. Where mixtures of these two fillers are employed the relative amounts thereof can be widely varied; the overall total not exceeding about 60 phr. The ratio of Austin black to cryogenically ground rubber may range from a desired ratio of 2:1 to perhaps even a ratio of 3:1. Again, as noted hereinabove, other filler materials can be employed. Amounts thereof fall within the range of amounts normally employed in preparing sulfur cured conventional sheeting.

Chemically modified reinforcing clays are known in the art. Cross-linking ability is imparted to the clay by modifying the surface of the individual particles with a polyfunctional silane coupling agent. Chemically modified clays may used in the amount of from about 20 parts to about 300 parts per 100 parts of rubber (phr), preferably in an amount from about 60 to 175 phr. The preferred range of chemically modified clays (60 to 175 phr) is about equal to the amount of carbon black normally used in preparing sulfur cured EPDM sheeting. Normally the specific gravity of most clays is about 2.60 at 25° C. The preferred chemically modified clays are commercially available from J. M. Huber Corporation and include: Nucap® 190, Nucap® 200, Nucap® 290, Nulok® 321, Nulok® 390 and Polyfil® 368. Another preferred chemically modified clay is Mercap® 100 commercially available from Kentucky-Tennessee Clay Company. Most preferred of these are Mercap® 100 and Nucap® 190.

A silicate may have utility in the present invention as an alternative filler. Synthetic amorphous calcium silicates are preferred and are commercially available from the J. M. Huber Company under the trademark Hubersorb 600. Hubersorb 600 is characterized as having an average particle size of 3.2 micrometers (by the Coulter Counter Method), oil absorption of 450 ml/100 g of calcium silicate, a BET (Brunaver-Emmet-Teller nitrogen adsorption procedure) surface area of 300 m²/g and a pH (5% solution) of about 10.

Other silicates which may be used to practice the present invention include precipitated, amorphous sodium aluminosilicates available from the J. M. Huber Company under the tradenames Zeolex 23 and Zeolex 80. Zeolex 23 has a BET surface area of about 75 m²/g, a refractive index at 20° C. of about 1.51, and a pH of about 10.2 determined by slurring 20 grams of silicate with 80 grams of deionized water. In comparison, Zeolex 80 has a BET surface area of about 115 m²/g, a refractive index at 20° C. of about 1.55, and a pH of about 7. The average particle size, density, physical form and oil absorption properties are similar to each other.

Reinforcing silicas are also used as fillers, optionally in conjunction with one or more of the chemically modified clays noted hereinabove. Silica (silicon dioxide) utilizes the element silicon and combines it in a very stable way with two oxygen atoms. Either crystalline or amorphous (noncrystalline) silicas may be used. The basic crystalline from of silica is quartz, although there are two other crystalline forms of silica that are less common—tridymite and cristobalite. On the other hand, the silicon and oxygen atoms can be arranged in an irregular form as can be identified by X-ray diffraction. This form of silica is classified as amorphous (noncrystalline), because there is no detectable crystalline silica as determined by X-ray diffraction.

A preferred silica, i.e., a fine particle, hydrated amorphous silica, is available from PPG Industries, Inc. in a low dust granular form under the tradename HiSil® 190G. Reinforcing silicas are generally characterized in terms of surface area (m²/g by the BET procedure) or particle size as determined by either transmission electron microscopy or the Coulter Counter Method. HiSil® 190G has an unexpectedly large surface area of 215 m²/g and an oil (DBP) absorption of about 269 ml/100 g. Generally speaking, a high surface area signifies a smaller particle size, and HiSil® 190G has a particle size of between about 16 and 17 nanometers as determined by the Coulter Counter Method. It is believed that the high surface area and small particle size tends to allow HiSil® 190G to be more reinforcing than other reinforcing silicas, such as, for example HiSil® 243 LD. Thus, HiSil® 190G is a more structured type of silica, which allows for the use of higher silica loadings compared to HiSil® 243LD. Also, the engineering process used to precipitate the two silicas utilizes different acids.

These silicas can be employed in the amount of about 10 parts to about 110 parts per 100 parts of rubber (phr), preferably in an amount from about 10 to 30 phr. The useful upper range is limited by the high viscosity imparted by fillers of this type.

In some instances, a number of other types of clays besides chemically modified clays may be useful. Three other basic types of clays which are normally used as reinforcing fillers for rubber elastomers include airfloated, water washed, and calcined clays.

The airfloated clays are the least expensive and most widely used. They are divided into two general groups, hard and soft, and offer a wide range of reinforcement and loading possibilities. Hard clays may be used in the amount of about 20 parts to about 300 parts per 100 parts of rubber (phr), preferably in an amount from about 65 to 210 phr. The preferred range of hard clays (65 to 210 phr) is about equal to or slightly higher than the amount of carbon black normally used in preparing sulfur cured EPDM sheeting. The preferred airfloated hard clays used are: Suprex®, Barden R®; and LGB®, all commercially available from J. M. Huber Corporation.

The airfloated soft clays are used in the amount of about 20 parts to about 300 parts per 100 parts of rubber (phr), preferably in an amount from about 75 to 235 phr. The preferred range of soft clays (75 to 235 phr) is also about equal to the amount of carbon black normally used in preparing sulfur cured EPDM sheeting. The preferred airfloated soft clays used are Paragon® and K-78® commercially available from J. M. Huber Corporation and Hi-White R® and Snobrite® Clay, commercially available from Evans Clay.

Water washed clays are normally considered as semi-reinforcing fillers. This particular class of clays is more closely controlled for particle size by the water-fractionation process. This process permits the production of clays within controlled particle size ranges. The preferred ranges of water washed clays are very similar to the preferred amounts of airfloated soft clays mentioned hereinabove. Some of the preferred water washed clays include Polyfil® DL, Polyfil® F, Polyfil® FB, Polyfil® HG-90, Polyfil® K and Polyfil® XB; all commercially available from J. M. Huber Corporation.

The third type of clay includes the calcined clay. Clays normally contain approximately 14 percent water of hydration, and most of this can be removed by calcination. The amount of bound water removed determines the degree of calcination. The preferred ranges of calcined clays are very similar to the preferred amounts of airfloated hard clays mentioned hereinabove. Some of the preferred calcined clays include Polyfil® 40, Polyfil® 70, and Polyfil® 80, all commercially available from J.M Huber Corporation.

Processing material may be included to improve the processing behavior of the composition (i.e. reduce mixing time and increase rate of sheet forming and includes processing oils, waxes and the like). When a processing oil is present, it may be included in an amount ranging from about 20 parts to about 150 parts process oil per 100 parts rubber, preferably in an amount ranging from about 60 parts to about 100 phr, and in one embodiment about 75 phr and in another embodiment about 90 phr. Suitable processing oils include paraffinic oils, e.g. Sunpar 2280 and Hyprene P150BS, which are available from the Sun Oil Company and Ergon Refining, Inc., respectively. Both of these petroleum-derived processing oils are characterized as having low aromaticity as well as less than about 0.2 wt. % sulfur and have refractive indices ranging from about 1.4888 to about 1.4925 at 20° C. The aniline points for these two paraffinic process oils range from about 123 to about 129° C. Other petroleum-derived oils, including naphthenic oils, may be used. Notably, the processing oil should be highly compatible with EPDM polymers.

The cure package ingredients include a curing agent and one or more accelerators. In particular, sulfur, other vulcanizing agents or mixtures thereof may be employed as the curing or vulcanizing agent in the membrane composition and may range from about 1.5 parts per hundred rubber (phr) to as high as 10 phr by weight with the preferred amounts ranging from about 1.5 to about 6 phr. Sulfur may employed in amounts of about 0.25 to 2 phr. In one example, 1 phr sulfur is used. As mentioned above, the sulfur cure package contains at least one thiazole accelerator and either a dithiocarbamate accelerator or a guanidine accelerator. Thiazole accelerators include 2-mercaptobenzothiazole; 2-(morpholinodithio)-benzothiazole disulfide; zinc 2-mercaptobenzothiazole and the like, the benzothiazole disulfides such as, for example, mercaptobenzothiazole disulfide (MBTS) and the benzothiazole sulfenamides, such as, for example, n-cyclohexyl-2-benzothiazole sulfenamide. Guanidine accelerators include N,N-diphenyl-guanidine, and N,N-di-(2-methylphenyl)guanidine. Dithiocarbamate accelerators include metal dialkyldithiocarbamates. Metal dialkyldithiocarbamates include, for example, zinc dibutyldithiocarbamate (ZnDBDC), zinc diethyldithiocarbamate, zinc dimethyldithiocarbamate, ferric dimethyldithiocarbamate, tellurium diethyldithiocarbamate, copper dimethyldithiocarbamate, bismuth dimethyldithiocarbamate, cadmium diethyldithiocarbamate, and lead dimethyldithiocarbamate.

The EPDM rubber liner material is devoid of thiuram accelerators. Optionally, the composition may also be devoid of sulfenamide accelerators. Specific vulcanization systems may further depend on the desired vulcanization conditions, e.g., vulcanization times, vulcanization temperatures, and vulcanizer pressure.

The use of a combination of MBTS and ZnDBDC as accelerators offers a number of advantages over other accelerators such as the thiuram accelerators including tetramethylthiuram monosulfide (TMTMS) and tetramethylthiuram disulfide (TMTDS). For example, this combination provides a lower raw material cost than these other accelerators listed hereinabove. They also do not release the ammonia and nitrite compounds discussed above like some of the other accelerators.

Optional ingredients include, for example, other elastomers (e.g., butyl elastomer, neutralized sulfonated EPDM, neutralized sulfonated butyl) in place of minor amounts of the EPDM, secondary inorganic fillers (e.g., talc, mica, clay, silicates, whiting) with total secondary filler content usually ranging from about 10 to about 65 phr, and conventional amounts of other conventional additives, such as zinc oxide, stearic acid, antioxidants, processing aids, antiozonants, and the like.

The compounding ingredients can be admixed, utilizing an internal mixer (such as a Banbury mixer), an extruder, and/or a two-roll mill, or other mixers suitable for forming viscous, relatively uniform admixtures. When utilizing a type B Banbury internal mixer, in a preferred mode, the dry or powdery materials such as the carbon black and mineral fillers as well as zinc oxide, stearic acid and antioxidant of the present invention are added first, followed by the liquid process oil and lastly the polymer, i.e., EPDM (this type of mixing can be referred to as an upside-down mixing technique). The resultant mixture forms a masterbatch to which the cure package can then be added. The cure package typically includes sulfur and one or more organic accelerators.

The resulting admixture may then be sheeted to a thickness ranging from about 5 to about 200 mils, and preferably from about 40 to about 60 mils, by conventional sheeting methods, for example, milling, calendering or extrusion. The admixture may also be bonded to another sheet material having essentially the same characteristics as the liner material of the present invention using conventional processing techniques. Typically, the plies are calendered separately and then laminated together in an uncured state, to be dusted with a release agent, positioned on a curing mandrel, and cured in an autoclave under steam and pressure, or by other means known in the art. The curing temperature should not exceed 160° C. The liner material can be visually inspected and cut to the desired length and width dimensions after curing.

Cured rubber liner materials suitable for use in ponds and other aquacultures may be optionally reinforced with scrim fabric as is well known in the art. However, scrim reinforcement is not necessary and could be undesirable in some applications.

Once the liner material is manufactured, it may be used in an aquaculture reservoir as a liner material for holding water. That is, the EPDM liner material and water contained by the liner material, form an aquaculture reservoir. The present invention may use fresh water, brackish water, or saltwater in the aquaculture reservoir, depending upon the type of aquatic animal intended to use the aquaculture reservoir. For example, shrimp are usually grown in salt water, while crayfish are usually grown in fresh water. As used herein, fresh water is water with a salinity level of up to 2 parts salt per thousand parts water (by weight), brackish water has a salinity content of about 2 to about 10 parts per thousand by weight, and salt water has a salinity content of about 10 to about 36 parts per thousand by weight. Seawater will typically have a salinity of at least about 30 parts per thousand by weight.

In another embodiment of the present invention, an aquaculture comprises the liner material described above, water contacting the liner material, and aquatic animals in the water, wherein a majority of the aquatic animals remain viable in the water for at least 7 days. That is, it has been discovered that the EPDM liner material of the present invention does not harm the viability of aquatic animals. By “viable’ is meant that at least a majority, and more preferably, at least 80%, of the aquatic animals are in a state of growth or at least maintain their mass for at least 7 days. Thus, viable aquatic animals are at least alive and, more preferably, are able to gain weight, remain very mobile, and are able to reproduce. It is possible for the aquatic animals to be alive and not be in a state of growth, i.e. they are in a state where they are limited in growth or mobility, either by exhaustion of one or more nutrients or by accumulation of waste products. In such a case, the animals are capable of resumed growth and mobility when non-limiting conditions are restored. It has been found that those EPDM liners that are toxic to aquatic animals, presumably because they permit or enhance the accumulation of ammonia and nitrites in the water possibly by leaching of the compounds from the EPDM liners, do not permit a majority of the aquatic animals to remain viable. Often, a majority of the aquatic animals will die within 7 days of existence in this habitat, although some may live longer depending upon the size of the reservoir, amount and type of contaminant and/or level of toxicity, and type of water employed. In any event, it is believed that the compounds toxic to aquatic plants and/or animals do not leach from EPDM liner materials of the present invention.

In light of the foregoing, it should also be evident that the present invention also provides a method for growing aquatic animals. The method includes at least partially lining an area with an EPDM aquaculture liner of the type described above to provide a lined container, placing water in the lined container, and placing aquatic animals in the water.

In order to demonstrate practice of the present invention, several EPDM liner material samples were prepared and subjected to a variety of tests to obtain data as to the physical properties of the resultant membranes prepared. The preferred EPDM polymer selected for these compositions was Keltan DE 2318. A more detailed characterization of this EPDM terpolymer was provided hereinabove.

Initially, the EPDM liners were prepared and tested for toxicity to nitrifying bacteria. Each of the samples was prepared utilizing standard rubber mixing techniques and equipment. Nitrifying bacteria were incubated in experimental vessels lined with an EPDM membrane. The bacteria were fed daily for six consecutive days and the amounts of residual ammonia and nitrite (in milligrams/liter) were measured. Nitrification activity tests were also conducted for 10, 33, and 55 days. For these tests, feeding and aeration are stopped and the cultures remain inactive until fed and aerated again. The average incubation temperature was about 29° C. (84° F.). During these tests, distilled water was added as needed to replace water lost due to evaporation. The sample number, accelerators used in the EPDM cure package, and ammonia levels at the above-mentioned time points are provided in Table 1. The sample number, accelerators used in the EPDM cure package, and nitrite levels at the time points are provided in Table 2. In Tables 1 and 2, the following abbreviations are used:
MBTS: 2-Mercaptobenzothiazyl disulfide
DPG: Diphenyl guanidine
ZnDBDC: Zinc dibutyldithiocarbamate

Morfax: 2-(morpholinodithio)-benzothiazole

TABLE 1
Ammonia Levels

| | | Ammo- | Ammo- | Ammo- | Ammo- |
|---|---|---|---|---|---|
| Sample | | nia - | nia - | nia - | nia - |
| No. | Accelerators | 6 days | 10 days | 33 days | 55 days |
| 1 | Azarate/ | >10 mg/l | >10 mg/l | >10 mg/l | >5 mg/l, |
| | TBBS | | | | <10 mg/l |
| 2 | DPG/MBTS | <5 mg/l | <5 mg/l | <5 mg/l | <5 mg/l |
| 3 | Royalac 136/ | <5 mg/l | >5 mg/l, | >10 mg/l | >5 mg/l, |
| | MBTS | | <10 mg/l | | <10 mg/l |
| 4 | TBBS/ | >10 mg/l | >10 mg/l | >10 mg/l | >5 mg/l, |
| | ZnDBDC | | | | <10 mg/l |
| 5 | MBTS/ | >10 mg/l | >10 mg/l | >10 mg/l | >10 mg/l |
| | ZnDBDC | | | | |
| 6 | Morfax/ | <5 mg/l | <5 mg/l | <5 mg/l | <5 mg/l |
| | ZnDBDC | | | | |
| Control- | — | <5 mg/l | <5 mg/l | <5 mg/l | <5 mg/l |
| no liner | | | | | |
| Control- | — | <5 mg/l | <5 mg/l | <5 mg/l | <5 mg/l |
| LDPE | | | | | |
| liner | | | | | |

TABLE 2
Nitrite Levels

| Sample | | Nitrite - 6 | Nitrite - | Nitrite - 33 | Nitrite - 55 |
|---|---|---|---|---|---|
| No. | Accelerators | days | 10 days | days | days |
| 1 | Azarate/ | <5 mg/l | <5 mg/l | >15 mg/l | >15 mg/l |
| | TBBS | | | | |
| 2 | DPG/MBTS | <5 mg/l | <5 mg/l | <5 mg/l | <5 mg/l |
| 3 | Royalac 136/ | <5 mg/l | <5 mg/l | <5 mg/l | <5 mg/l |
| | MBTS | | | | |
| 4 | TBBS/ | <5 mg/l | <5 mg/l | <5 mg/l | <5 mg/l |
| | ZnDBDC | | | | |
| 5 | MBTS/ | <5 mg/l | <5 mg/l | <5 mg/l | <5 mg/l |
| | ZnDBDC | | | | |
| 6 | Morfax/ | <5 mg/l | <5 mg/l | <5 mg/l | <5 mg/l |
| | ZnDBDC | | | | |
| Control- | — | <5 mg/l | <5 mg/l | <5 mg/l | <5 mg/l |
| no liner | | | | | |
| Control- | — | <5 mg/l | <5 mg/l | <5 mg/l | <5 mg/l |
| LDPE | | | | | |
| liner | | | | | |

The data provided in Tables 1 and 2 demonstrate that EPDM synthesized with a sulfur cure package containing a thiazole accelerator and either a guanidine accelerator or a dithiocarbamate accelerator (Samples 2 and 6) have no significant inhibitory effect on ammonia oxidation or nitrite oxidation, similar to both the no liner control and LDPE liner control. While one EPDM liner material sample containing a thiazole accelerator and a dithiocarbamate accelerator was shown to inhibit the activity of ammonia reducing bacteria (Sample 5), further testing of a that liner material composition revealed that animals grown in an aquaculture containing this liner material were not inhibited in their growth and remained viable.

Two additional samples were synthesized and tested for their suitability as aquaculture liners, i.e. they were tested for non-inhibition of aquatic animal survival and growth when used as aquaculture liner. The membranes were prepared utilizing standard rubber mixing techniques and equipment by mixing together the ingredients listed in Table 3.

As is typical for rubber liners, the unaged physical properties of the membranes were tested and evaluated using test methods developed for typical mechanical rubber goods. The results of these tests are provided in Table 4, including processing safety, compound viscosity, die “C” tear resistance, trouser tear properties, stress-strain properties, and Shore “A” hardness.

TABLE 3
EPDM Membranes for AquaCulture Liners

| | Sample Nos. | | | |
|---|---|---|---|---|
| | 7 | | 8 | |
| | PPHR | (in %) | PPHR | (in %) |
| EPDM | 100 | (28.55) | 100 | (28.48) |
| GPF carbon black | 70.98 | (20.27) | 70.98 | (20.22) |
| HAF carbon black | 25.20 | (7.20) | 25.20 | (7.18) |
| Coal Filler | 38.50 | (10.99) | 38.50 | (10.97) |
| Clay (untreated) | 31.87 | (9.10) | 31.87 | (9.08) |
| Process oil | 76.32 | (21.79) | 76.32 | (21.74) |
| Zinc oxide | 3.0 | (0.86) | 3.0 | (0.85) |
| Stearic acid | 1.50 | (0.43) | 1.50 | (0.43) |
| Rubber Masterbatch | 347.37 | | 347.37 | |
| Sulfur | 0.95 | (0.27) | 0.95 | (0.27) |
| Zinc Dibutyldithiocarbamate | 0.40 | (0.11) | — | |
| Morfax accelerator | 1.50 | (0.43) | — | |
| MBTS accelerator | — | | 2.25 | (0.64) |
| DPG accelerator | — | | 0.50 | (0.14) |
| TOTAL | 350.22 | (100.00) | 351.07 | (100.00) |

PPHR = Parts per 100 rubber (polymer)

TABLE 4
EPDM Membranes for AquaCulture Liners

Sample Nos.

| | 7 | 8 |
|---|---|---|
| Rheometer at 160° C., mini-die | | |
| Scorch time, minutes | 2.89 | 7.53 |
| Time to 90% cure, minutes | 23.54 | 24.66 |
| Minimum torque | 8.12 | 7.33 |
| Maximum torque | 42.43 | 35.13 |
| Mooney Scorch at 135° C. - | | |
| large rotor | | |
| Minimum Viscosity | 43.2 | 42.4 |
| T₅, minutes | 11.48 | 31.62 |
| T₃₅, minutes | 21.92 | 53.28 |
| Stress-Strain Properties at 23° C. - | | |
| Slabs cured 30 minutes at 160° C. | | |
| 100% Modulus, psi | 395 | 370 |
| 300% Modulus, psi | 985 | 847 |
| Tensile at break, psi | 1434 | 1363 |
| Elongation at break, % | 505 | 513 |
| Die C Tear Properties at 23° C. - | | |
| Slabs cured 30 minutes at 160° C. | | |
| Lbs./Inch | 213 | 218 |
| Trouser Tear at 23° C. - | | |
| Machine direction | | |
| Lbs./Inch | 140 | 146.3 |
| | (Hook-tears) | (Hook-tears) |
| Trouser Tear at 23° C. - | | |
| Cross direction | | |
| Lbs./Inch | 154 | 163 |
| | (Hook-tears) | (Hook-tears) |
| Shore “A” Hardness | | |
| Unaged - Tested at 23° C. | 65 | 63 |

The cure characteristics of the EPDM rubber compositions were determined by means of a Monsanto Oscillating Disc Rheometer (described in detail in American Society for Testing and Materials Standard ASTM D 2084). The metal die used to measure the scorch time, cure rates and state of cure is referred to as a mini-die. During testing, the die oscillated at a 30 arc.

The test method (ASTM D 1646) covers the use of the shearing disk viscometer for measuring the Mooney Viscosity of raw polymers and fully compounded rubber compositions. The viscosity of the fully compounded rubber compositions can be detected with this instrument as evidenced by an increase in viscosity. Therefore, this test method can be used to determine incipient cure time and the rate of cure during very early stages of vulcanization.

For testing purposes, dumbbell-shaped specimens were cut using the appropriate metal die from individually cured 45 mil six by six-inch flat rubber slabs (compression molded 30 minutes at 160° C.) in accordance with ASTM D 412 (Method A—dumbbell and straight). Modulus, tensile strength and elongation at break measurements were obtained on both unaged and heat aged (28 days at 116° C.) dumbbell-shaped test specimens using a table model Instron® Tester, Model 4301, and the test results were calculated in accordance with ASTM D 412. Heat aged test specimens were taken from cured slabs which were aged in a forced air oven for 28 days at 116° C. in accordance with ASTM D 573. Heat aging is an accelerated aging test designed to determine the effect of heat on the thermal stability of the chemical crosslinks formed during the actual vulcanization process. All dumbbell-shaped specimens either unaged or heat aged were allowed to set for about 24 hours, before testing was carried out at 23° C. The Instron® Tester (a testing machine of the constant rate-of-jaw separation type) is equipped with suitable grips capable of clamping the test specimens without slippage.

Tear properties were determined by using a metal die (die C, 90° angle) to remove the test specimens from cured 45 mil six by six-inch flat rubber slabs (compression molded 30 minutes at 160° C.) in accordance with ASTM D 624. All die C tear specimens, both unaged and heat aged (28 days at 116° C.) were allowed to set for about 24 hours, before testing was carried out at 23° C.

The heat aged specimens were taken from cured slabs which were aged in a forced air oven for 28 days at 116° C. in accordance with ASTM D 573. Oven aging is an accelerated heat aging test designed to determine the effect of heat on the thermal stability of the chemical crosslinks formed during the actual vulcanization process. Tear properties, in lbs./inch, were obtained using a table model Instron Tester, Model 4301 and the test results were calculated in accordance with ASTM Method D 624.

Trouser tear properties were measured using test specimens (one by three-inches in length) prepared in accordance with the International Standard Organization (ISO) 34 (first edition—Oct. 1, 1979). The heat aged trouser tear test specimens were taken from cured 6-inch by 6-inch rubber slabs that were aged in a forced air oven for 28 days at 116° C. in accordance with ASTM D 573. Tear properties, in lbs./inch, were determined at 23° C. using a table model Instron® Tester, Model 4301 and the test results were calculated in accordance with ISO 34.

Shore “A” hardness, which measures the hardness of the cured membrane compound, was conducted at 23° C. in accordance with ASTM Method D 2240. The cured test specimens were allowed to set for about 24 hours prior to testing.

Liner material made from the EPDM compositions of samples 7 and 8, as well as another EPDM composition according to the present invention were then used in an aquaculture reservoir as aquaculture liners (Samples A, B, and C in Table 5). In particular, a 70-day test was designed to evaluate the effects of the EPDM liners on survival, growth, and selected water quality indicators in a static tank-system stocked with juveniles of the Pacific white shrimp Litopenaeus vannamei. A known to be non-toxic liner of high density polyethylene (HDPE) served as a liner control (Sample D in Table 5). Tanks with no liner served as a no-liner control (Sample E in Table 5). There were six tank replicates for each treatment, all open to the atmosphere. Each tank was stocked with 26 shrimp and measured as having 610 L working volume and a 0.85 m² bottom area. Every tank was provided with two 0.91 m² sheets of one of the EPDM test liners or the HDPE control liner. The liners were suspended vertically in the water column resulting in two 0.6 m by 0.55 m sheets exposed on both sides of the tank water, which provided a total liner surface area of 1.32 m². Two airstones provided mixing and aeration in each tank. Tanks were positioned under a shade with a roof that enabled partial penetration of direct sunlight. Shrimp were fed four times daily a 35% protein commercial diet. Dissolved oxygen, temperature, pH and salinity were monitored twice daily, while ammonia-nitrogen and nitrite-nitrogen were monitored once a week in all tanks. Shrimp survival rates and final average weight, as well as several water quality indicators were monitored weekly. Five shrimp from each of the tanks were collected weekly to estimate growth (group weight) and to adjust daily rations.

The survival rate results and the average final weight of the shrimp in the tanks were determined and are set forth in Table 5 below.

TABLE 5
70-Day Shrimp Survival Rates and Weight Average

| | Survival Rate | Average Final Weight |
|---|---|---|
| Sample Nos. | (%) | (grams) |
| EPDM Liner A | 97.7 | 12.89 |
| EPDM Liner B | 93.1 | 13.01 |
| EPDM Liner C | 88.5 | 12.92 |
| HDPE Liner D (control) | 96.8 | 12.73 |
| No Liner E (control) | 98.5 | 14.94 |

The results of the 70-day test showed no statistically significant differences in the daily oxygen, salinity, pH or temperature between all tested tanks. Survival rates at the end of the 70-day test ranged between 88.5 percent and 98.5 percent. There were no statistically significant differences in the average survival rates between the three EPDM liners, the HDPE control liner and the no-liner control. Shrimp average final weight in the three EPDM and HDPE control liners ranged from 12.29 grams to 13.01 grams, with no statistically significant difference, although the no liner control was higher. There was also no statistically significant difference during the study and at the termination thereof in the level of ammonia-nitrogen, nitrite-nitrogen or nitrate-nitrogen.

As a result, it can be seen that the shrimp in tanks employing the EPDM liners of the present invention maintained essentially the same growth as the shrimp in the currently commercially acceptable HDPE liner. More importantly, it has been found that a majority, preferably at least 80%, and even more preferably at least 88%, of the aquatic animals remained alive and viable in aquacultures utilizing EPDM liners for at least 70 days.

Thus it should be evident that the EPDM liner material and method of the present invention are highly effective in providing a liner for a commercial aquaculture system. The invention is particularly suited for use in commercial aquaculture, but is not necessarily limited thereto. The liner material of the present invention can also be used separately with other equipment, methods and the like, for noncommercial aquaculture linings, such as for fish ponds, decorative and aquatic gardens, ponds on golf courses, and the like.

Based upon the foregoing disclosure, it should now be apparent that the use of the liners described herein will carry out the objects set forth hereinabove. It is, therefore, to be understood that any variations evident fall within the scope of the claimed invention and thus, the selection of specific component elements can be determined without departing from the spirit of the invention herein disclosed and described. In particular, it will be understood that the rubber compositions exemplified herein according to the present invention are not necessarily limited to those having using the EPDM terpolymers exemplified above. Moreover, as noted hereinabove, other fillers and processing oils might be substituted for the specific fillers and oils exemplified hereinabove, and other ingredients may be optionally employed. Thus, the scope of the invention shall include all modifications and variations that may fall within the scope of the attached claims.

1. An aquaculture comprising:
a liner material including at least one cured ethylene-propylene-diene terpolymer, where the terpolymer includes a crystallinity of less than 1 percent, and carbon black, where the terpolymer is cured with a cure package that includes a curing agent and at least one thiazole accelerator and at least one accelerator selected from the group consisting of dithiocarbamate accelerators and guanidine accelerators, and is devoid of thiuram accelerators;
water contacting said liner material; and
aquatic animals in said water, wherein a majority of the animals remain viable in said water for at least 7 days.

2. The aquaculture of claim 32, wherein at least one of ammonia oxidizing bacteria and nitrite oxidizing bacteria are contacted with said water, and wherein said bacteria are biologically active in the water.

3. (canceled)

4. The aquaculture of claim 32, wherein said liner material further includes at least one filler selected from the group consisting of ground coal, calcium carbonate, clay, silica, mica, talc and cryogenically ground rubber.

5. (canceled)

6. The aquaculture of claim 32, wherein said liner material further includes at least one processing oil selected from the group consisting of paraffinic oils, naphthenic oils and mixtures thereof.

7. (canceled)

8. The aquaculture of claim 32, wherein said water is salt water.

9. The aquaculture of claim 32, wherein said aquatic animals are selected from the group consisting of shrimp and crayfish.

10. A method for growing aquatic animals, the method comprising:
at least partially lining an area with an aquaculture liner to provide a lined reservoir, wherein said aquaculture liner comprises at least one cured ethylene-propylene-diene terpolymer including a crystallinity of less than 1 percent, and carbon black where the terpolymer is cured with a cure package that includes a curing agent and at least one thiazole accelerator selected from the group consisting of dithiocarbamate accelerators and guanidine accelerators, and is devoid of thiuram accelerators;
placing water in the lined container; and
placing aquatic animals in the water.

11. The method of claim 10, wherein the water is salt water.

12. The method of claim 10, wherein said aquatic animals are selected from the group consisting of shrimp or crayfish.

13. The method of claim 10, the method further comprising the step of contacting the water with at least one of the group consisting of ammonia oxidizing bacteria and nitrite oxidizing bacteria, wherein said bacteria are biologically active in the water.

14. (canceled)

15. The method of claim 10, wherein said aquaculture liner further comprises at least one filler selected from the group consisting of ground coal, calcium carbonate, clay, silica, mica, talc and cryogenically ground rubber.

16. The method of claim 10, wherein said curing agent is sulfur.

17. The method of claim 10, wherein said aquaculture liner further comprises at least one processing oil selected from the group consisting of paraffinic oils, naphthenic oils and mixtures thereof.

18-24. (canceled)

25. An aquaculture liner comprising:
a cured amorphous ethylene-propylene-diene terpolymer including less than 1 percent crystallinity;
and carbon black, and where the terpolymer is cured with a cure package that is devoid of thiuram accelerators.

26. The aquaculture liner of claim 25, wherein said liner further includes at least one filler selected from the group consisting of ground coal, calcium carbonate, clay, silica, mica, talc and cryogenically ground rubber.

27. The aquaculture liner of claim 25, wherein said liner further includes at least one processing oil selected from the group consisting of paraffinic oils, naphthenic oils and mixtures thereof.

28. The aquaculture liner of claim 25, wherein said curing agent is sulfur.

29. The aquaculture of claim 9, wherein a majority of said shrimp and said crayfish remain viable in said water for at least seven days.

30. The method of claim 10, wherein said aquatic animals are selected from the group consisting of shrimp and crayfish.

31. The method of claim 10, wherein a majority of said shrimp and said crayfish remain viable in said water for at least seven days.

32. An aquaculture comprising:
a liner including a cured ethylene-propylene-diene terpolymer including less that 1 percent crystallinity and carbon black, where the terpolymer is cured with a cure package that is devoid of thiuram accelerators;
water contacting said liner material; and
aquatic animals in said water.
